(19) United States
(12) Patent Application Publication
(10) Pub. No.: US 2015/0221950 A1
(43) Pub. Date: Aug. 6, 2015

(54) NEGATIVE ELECTRODE ACTIVE MATERIAL FOR NON-AQUEOUS ELECTROLYTE SECONDARY BATTERIES AND NON-AQUEOUS ELECTROLYTE SECONDARY BATTERY USING NEGATIVE ELECTRODE ACTIVE MATERIAL

(71) Applicant: SANYO Electric Co., Ltd., Daito-shi, Osaka (JP)

(72) Inventors: Hiroshi Minami, Hyogo (JP); Naoki Imachi, Hyogo (JP)

(73) Assignee: SANYO Electric Co., Ltd., Daito-shi, Osaka (JP)

(21) Appl. No.: 14/420,732

(22) PCT Filed: Sep. 11, 2013
(86) PCT No.: PCT/JP2013/005377

§ 371 Date: Feb. 10, 2015

(30) Foreign Application Priority Data
Sep. 27, 2012 (JP) 2012-214841
Mar. 25, 2013 (JP) 2013-061394

(51) Int. Cl. H01M 4/58; H01M 10/0525; H01M 4/587; H01M 4/36; H01M 4/525

(52) U.S. Cl. CPC H01M 4/5825; H01M 4/366; H01M 4/525; H01M 4/587; H01M 10/0525; H01M 2004/027

(57) ABSTRACT

In a non-aqueous electrolyte secondary battery using SiO_{X} as a negative electrode active material, it is an object to improve initial charge-discharge efficiency and cycle properties. Provided is a negative electrode active material containing particles made of SiO_{X} containing a lithium silicate phase, 50% to 100% of the surface of each particle made of SiO_{X} being covered by carbon. The proportion of the number of moles of the lithium silicate phase to the number of moles of the particles made of SiO_{X} is 0.5 mole percent to 25 mole percent. The average primary particle size of the particles made of SiO_{X} is 1 μm to 15 μm.

### TECHNICAL FIELD

The present invention relates to a negative electrode active material for non-aqueous electrolyte secondary batteries and a non-aqueous electrolyte secondary battery using the negative electrode active material.

### BACKGROUND ART

A silicon oxide represented by SiO_{X} has high specific capacitance and a less volumetric expansion coefficient as compared to Si when absorbing lithium during charge. Therefore, the use of a mixture of the silicon oxide and graphite as a negative electrode active material is under investigation (refer to Patent Literature 1).

However, there is a problem in that a non-aqueous electrolyte secondary battery using the silicon oxide, which is represented by SiO_{X}, as a negative electrode active material has significantly reduced initial charge-discharge efficiency and capacity in initial cycles as compared to the case of using graphite only as a negative electrode active material.

In order to enhance initial charge-discharge efficiency, the following particles have been proposed: composite particles having a structure in which a silicon oxide is distributed in a carbonaceous active material and in which silicon and a lithium silicate phase are present in the silicon oxide (refer to Patent Literature 2).

### CITATION LIST

### Patent Literature

PTL 1: Japanese Published Unexamined Patent Application No. 2011-233245

PTL 2: Japanese Published Unexamined Patent Application No. 2007-59213

### SUMMARY OF INVENTION

### Technical Problem

However, in the proposal described in Patent Literature 2, the silicon oxide distributed in the carbonaceous active material has a structure in which the silicon oxide is dispersed in a carbon matrix and therefore the carbon matrix inhibits the diffusion of lithium during charge and discharge. Therefore, lithium does not sufficiently reach the silicon oxide in some cases. There is a problem in that the actual capacity of a battery is significantly less than the theoretical capacity thereof and the initial charge-discharge efficiency thereof is low.

### Solution to Problem

A negative electrode active material according to the present invention contains particles made of SiO_{X} (0.8≦X≦1.2) containing a lithium silicate phase, 50% to 100% of the surface of each particle made of SiO_{X} being covered by carbon.

### Advantageous Effects of Invention

According to an embodiment the present invention, in a non-aqueous electrolyte secondary battery using SiO_{X} as a negative electrode active material, initial charge-discharge efficiency and cycle properties are significantly enhanced.

### BRIEF DESCRIPTION OF DRAWINGS

FIG. 1 is a graph showing results obtained by measuring SiO_{X} in Batteries A1 and Z by XRD.

### DESCRIPTION OF EMBODIMENTS

In this specification, the term “substantially . . . ” is intended to include completely the same something and those regarded as substantially identical, as described using the term “substantially the same” as an example.

A negative electrode active material according to the present invention contains particles made of SiO_{X} (0.8≦X≦1.2) containing a lithium silicate phase, 50% to 100% of the surface of each particle made of SiO_{X} being covered by carbon.

In a non-aqueous electrolyte secondary battery using the negative electrode active material having the above configuration, initial charge-discharge efficiency and cycle properties can be enhanced. Reasons for this are described below.

SiO_{X} is a fine mixture of Si and SiO₂. An initial charge reaction in the case of using SiO_{X} as the negative electrode active material can be generally represented by the following equation:

4SiO(2Si+2SiO₂)+16Li⁺+16e⁻→3Li₄Si+Li₄SiO₄ (1).

As shown in Equation (1), Li₄SiO₄, which is produced during initial charge, is an irreversible reaction product. Thus, Si in SiO_{X} does not all react irreversibly, thereby causing a reduction in theoretical efficiency. In particular, in the case where Li₄SiO₄ is produced in the form of an irreversible reaction product as shown in Equation (1), four of 16 lithium ions are irreversible and therefore the theoretical efficiency is 75%.

Therefore, SiO_{X} containing the lithium silicate phase, such as Li₄SiO₄, is used to prepare a battery (before initial charge) like the above configuration. According to this configuration, the amount of lithium consumed by an irreversible reaction product during initial charge is small; hence, the initial charge-discharge efficiency can be significantly improved. The SiO_{X} particles are increased in volume by forming the lithium silicate phase. Therefore, in the case of using SiO_{X} as the negative electrode active material, SiO_{X} containing the lithium silicate phase has less displacement due to expansion or shrinkage during charge or discharge as compared to SiO_{X} containing no lithium silicate phase. Thus, the use of SiO_{X} containing the lithium silicate phase allows separation in a negative electrode mix layer and the separation between the negative electrode mix layer and a negative electrode current collector to be suppressed and therefore allows cycle properties to be enhanced. In addition, no carbon matrix is present around SiO_{X} and therefore lithium diffuses smoothly. Thus, the actual capacity of the battery is large.

Incidentally, the lithium silicate phase may possibly be composed of not only Li₄SiO₄ but also Li₂SiO₃ and the like, which are electrochemically inert. The lithium silicate phase is not electrochemically formed but is formed by a chemical reaction. The lithium silicate phase can be formed by, for example, a method below.

The lithium silicate phase can be formed in SiO_{X} in such a manner that, for example, a lithium compound such as LiOH, Li₂CO₃, LiF, or LiCl and SiO_{X} are mixed together and are heat-treated at high temperature. Herein, a reaction occurring in the case of using LiOH as the lithium compound is represented by Equation (2) below. As is clear from Equation (2), SiO₂ present in SiO_{X} reacts with LiOH to produce Li₄SiO₄.

SiO₂+4LiOH→Li₄SiO₄+2H₂O (2)

The lithium silicate phase is a compound of Li, Si, and O and includes Li₂SiO₂ and Li₂Si₂O₅ in addition to Li₄SiO₄. A product may possibly differ depending on the amount of the added lithium compound and a treatment method.

The proportion of the lithium silicate phase to the amount of the SiO_{X} (0.8≦X≦1.2) particles is preferably 0.5 mole percent to 25 mole percent. When the proportion of the lithium silicate phase is less than 0.5 mole percent, the effect of improving the initial charge-discharge efficiency is low. However, when the proportion of the lithium silicate phase is more than 25 mole percent, the amount of Si that reacts reversibly is small and therefore the charge-discharge capacity is low.

In the present invention, carbon covers 50% to 100% of the surface of SiO_{X} and preferably 100%. This is because when 50% to 100% of the surface of SiO_{X} is covered by carbon, the direct contact of the lithium compound with SiO_{X} can be suppressed during the formation of the lithium silicate phase in SiO_{X} and therefore the homogeneous reaction of lithium with SiO_{X} can be carried out in the SiO_{X} particles. In the present invention, the fact that the surface of SiO_{X} is covered by carbon means that the surface of each SiO_{X} particle is covered by the carbon coating with a thickness of at least 1 nm or more in the case of observing a cross section of the particle by SEM. In the present invention, the fact that 100% of the surface of SiO_{X} is covered by carbon means that substantially 100% of the surface of each SiO_{X} particle is covered by a carbon coating with a thickness of at least 1 nm or more in the case of observing a cross section of the particle by SEM. When being covered by carbon, the surface of SiO_{X} is preferably uniformly covered such that the reaction homogeneity of SiO_{X} is increased. The thickness of the carbon coating is preferably 1 nm to 200 nm. When the thickness is less than 1 nm, the conductivity is low and uniform covering is difficult. However, when the thickness is more than 200 nm, the carbon coating inhibits the diffusion of lithium, lithium does not sufficiently reach SiO_{X}, and the capacity decreases significantly. Furthermore, when being covered by carbon, the proportion of carbon to SiO_{X} is preferably 10% by mass or less.

In the present invention, the average primary particle size of SiO_{X} is preferably 1 μm to 15 μm. When the average primary particle size of SiO_{X} is less than 1 μm, the surface area of each particle is excessively large, the amount of reaction with an electrolyte solution is high, and the capacity may possibly decrease. Furthermore, the expansion and shrinkage of SiO_{X} are small and the influence on the negative electrode mix layer is small. Therefore, even if the lithium silicate phase is not formed in SiO_{X} in advance, separation is unlikely to occur between the negative electrode mix layer and the negative electrode current collector and cycle properties do not decrease significantly. However, when the average primary particle size of SiO_{X} is more than 15 μm, lithium does not diffuse in SiO_{X} during the formation of the lithium silicate phase and therefore the lithium silicate phase may possibly be formed on the surface of SiO_{X}. Since the lithium silicate phase is insulating, such a structure inhibits the diffusion of lithium and therefore lithium cannot diffuse to the vicinity of the center of SiO. This may possibly cause a reduction in capacity or reductions in load properties. Thus, the average primary particle size of SiO_{X} is preferably 1 μm to 15 μm and particularly preferably 4 μm to 10 μm.

Incidentally, the average primary particle size (D₅₀) of SiO_{X} is the cumulative 50 volume percent diameter in a particle size distribution determined by a laser diffraction/scattering method.

In the present invention, SiO_{X} may be used alone as the negative electrode active material or may be used in combination with a carbonaceous active material such as graphite or hard carbon. Since SiO_{X} is higher in specific capacitance than carbonaceous active material, increasing the amount of added SiO_{X} allows the capacity to be increased. However, SiO_{X} has a larger expansion coefficient and shrinkage coefficient during charge and discharge as compared to the carbonaceous active material. When the proportion thereof is excessively large, separation occurs at the interface between the negative electrode mix layer and the negative electrode current collector, conductive contact between particles of the negative electrode active material, and therefore cycle properties may possibly decrease significantly. Thus, in the case of using SiO_{X} and the carbonaceous active material in combination, the proportion of SiO_{X} to the amount of the negative electrode active material is preferably 20% by mass or less. However, when the proportion of SiO_{X} is excessively small, the merit of increasing the capacity by adding SiO_{X} is small. Therefore, the proportion of SiO_{X} to the amount of the negative electrode active material is preferably 1% by mass or more.

A positive electrode and a non-aqueous electrolyte solution are those for use in non-aqueous electrolyte secondary batteries and can be used without specific limitations.

Examples of the positive electrode active material include lithium cobaltate, nickel- or manganese-containing lithium composite oxides, olivine-type lithium phosphate typified by lithium iron phosphate (LiFePO₄), and the like. Examples of the nickel- or manganese-containing lithium composite oxides include lithium composite oxides such as Ni—Co—Mn, Ni—Mn—Al, and Ni—Co—Al. The positive electrode active material may use these compounds alone or in combination.

When the positive electrode active material contains an oxide containing lithium and a metal element M and the metal element M includes at least one selected from the group consisting of cobalt and nickel, the ratio x/M_{c} of the sum x of the amount of lithium contained in a positive electrode and the amount of lithium contained in a negative electrode to the amount M_{c} of the metal element M contained in the oxide is preferably more than 1.01 and more preferably more than 1.03.

When the ratio x/M_{c} is within the above range, the proportion of lithium ions supplied into a battery is very large. That is, this is advantageous in compensating for irreversible capacity.

When the negative electrode active material is a mixture of SiO_{X} containing the lithium silicate phase and the carbonaceous active material, the ratio x/M_{c} varies depending on the proportion of SiO_{X} to the amount of the negative electrode active material or the like.

The ratio x/M_{c} can be calculated in such a manner that the amount x of lithium contained in the positive electrode and the negative electrode and the amount M_{c} of the metal element M contained in the positive electrode active material are determined and the amount x is divided by the amount M_{c} of the metal element M.

The amount x of lithium and the amount M_{c} of the metal element M can be determined as described below.

After a battery is completely discharged, the battery is disassembled, the non-aqueous electrolyte solution is removed, and an inner portion of the battery is cleaned with a solvent such as dimethyl carbonate. Next, a predetermined mass is taken from each of the positive electrode and the negative electrode and the amount of lithium contained in each of the positive electrode and the negative electrode is determined by ICP analysis, whereby the amount (molar quantity) x of lithium is determined. Furthermore, the amount (molar quantity) M_{c} of the metal element M contained in the positive electrode is determined by ICP analysis similarly to the case of the amount of lithium in the positive electrode.

A solvent and solute in the non-aqueous electrolyte solution are not particularly limited and may be those that can be used in non-aqueous electrolyte secondary batteries.

The following compound can be used as the solute in the non-aqueous electrolyte solution: LiBF₄, LiPF₆, LiN(SO₂CF₃)₂, LiN(SO₂C₂F₅)₂, LiPF₆₋ₓ(CₙF₂ₙ₊₁)ₓ [where 1<x<6 and n=1 or 2], or a lithium salt containing an oxalato complex anion. The following compound can be used as the oxalato complex anion-containing lithium salt: LiBOB (lithium bis(oxalate)borate) or a lithium salt containing an anion containing an central atom coordinated with C₂O₄²⁻, the lithium salt being represented by, for example, Li[M(C₂O₄)ₓR_{y}] (where M is an element selected from transition metals, Group IIIb, Group IVb, and Group Vb in the periodic table; R is a group selected from halogens, alkyl groups, and halogen-substituted alkyl groups; x is a positive integer, and y is 0 or a positive integer). In particular, there are Li[B(C₂O₄)F₂], Li[P(C₂O₄)F₄], Li[P(C₂O₄)₂F₂], and the like. Incidentally, LiBOB is most preferably used to form a coating stable in high-temperature environments on a surface of the negative electrode.

Incidentally, the solute may be used alone or two or more types of solutes may be used in combination. The concentration of the solute is not particularly limited and is preferably 0.8 mole to 1.8 moles per liter of the electrolyte solution. Furthermore, in applications requiring large-current discharge, the concentration of the solute is preferably 1.0 mole to 1.6 moles per liter of the electrolyte solution.

On the other hand, the following solvent is preferably used as the solvent in the non-aqueous electrolyte solution: a carbonate solvent such as ethylene carbonate, propylene carbonate, γ-butyrolactone, diethylene carbonate, methyl ethyl carbonate, or dimethyl carbonate or a carbonate solvent in which hydrogen is partly substituted by F. The solvent used is preferably a mixture of a cyclic carbonate and a linear carbonate.

Incidentally, differences between the invention described in Patent Literature 2 are as described below.

(1) In the present invention, the surface of SiO_{X} is covered by carbon as described above. Thus, in not only the invention described in Patent Literature 2 but also the present invention, carbon is contained in the SiO_{X} particles. In the invention described in Patent Literature 2, carbon is present in the particles. However, in the present invention, carbon is present only on the surface of each particle. Regarding this, in the present invention, the percentage of carbon in the particle is extremely low, about 10% by mass or less. However, in the invention described in Patent Literature 2, the percentage is extremely high, about 50% by mass or more.

(2) In the invention described in Patent Literature 2, heat treatment is performed in the presence of an SiO powder, a carbon powder, and a lithium compound. Thus, lithium in the lithium compound is absorbed into not only SiO but also carbon. However, in the present invention, heat treatment is performed in the presence of an SiO powder and the lithium compound, followed by mixing with a carbon powder. Thus, lithium in the lithium compound is absorbed into SiO only (not absorbed into carbon).

(3) In the case of a structure in which SiO_{X} is distributed in a carbon matrix as disclosed in the invention described in Patent Literature 2, the particle size of SiO_{X} is small and SiO_{X} is covered by the carbon matrix, which can relieve stress. Thus, the influence (the separation between a negative electrode mix layer and a negative electrode current collector) of the expansion and shrinkage of a negative electrode active material during charge and discharge on a negative electrode mix layer is small. Therefore, in the invention described in Patent Literature 2, the effect of enhancing battery properties by reducing the expansion and shrinkage of the negative electrode active material is only slightly exhibited.

However, in the case of using a mixture of graphite and the particles (particles of SiO_{X} only) made of SiO_{X} containing the liquid crystal panel as disclosed in the present invention, the particle size of SiO_{X} needs to be large in some sense and no matrix capable of relieving stress is present around SiO_{X}. Thus, the influence of the expansion and shrinkage of the negative electrode active material on the negative electrode mix layer is extremely large. Therefore, in the present invention, the effect of enhancing battery properties by reducing the expansion and shrinkage of the negative electrode active material is significantly exhibited.

### Examples

The present invention is further described below in detail with reference to specific examples. The present invention is not limited to the examples below and can be appropriately modified without departing from the scope of present invention.

### First Example

### Example 1

### Preparation of Negative Electrode

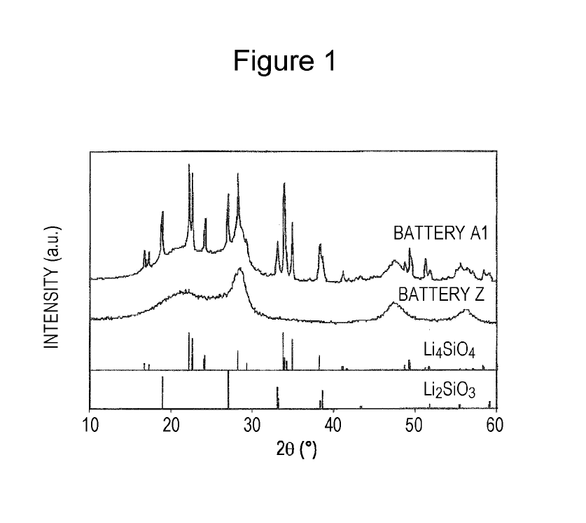

SiO_{X} (X=0.93, an average primary particle size of 5.0 μm) of which the surface was covered by carbon was prepared. Incidentally, covering was performed by a CVD method. The proportion of carbon to SiO_{X} was 10% by mass. The carbon coverage of the surface of SiO_{X} was 100%. One mole of SiO_{X} and 0.2 mol of LiOH were mixed together in a powdery state (the proportion of LiOH to SiO_{X} was 20 mole percent), whereby LiOH was applied to the surface of SiO_{X}. Next, heat treatment was performed at 800° C. for 10 hours in an Ar atmosphere, whereby a lithium silicate phase was formed in SiO_{X}. Heat-treated SiO_{X} was analyzed by XRD (the radiation source is Cu Kα), whereby peaks corresponding to Li₄SiO₄ and Li₂SiO₃, which are lithium silicates, were observed as shown in FIG. 1. The number of moles (hereinafter referred to as the percentage of the lithium silicate phase in SiO_{X}) of the lithium silicate phase to the number of moles of SiO_{X} was 5 mole percent.

The carbon coverage of the surface of SiO_{X} was confirmed by a method below. A cross section of a particle of a negative electrode active material was exposed using an ion milling system (ex. IM4000) manufactured by Hitachi High-Technologies Corporation and was confirmed using a SEM and a reflection electron image. The interface between a carbon coating layer and SiO_{X} in the cross section of the particle was identified from the reflection electron image. The proportion of carbon coatings, present on the surface of each particle of SiO_{X}, having a thickness of 1 nm or more was calculated from the ratio of the sum of the lengths of the interfaces between the carbon coatings having a thickness of 1 nm or more and SiO_{X} to the perimeter of SiO_{X} in the cross section of the particle. The average of the proportions of the carbon coatings on 30 of the SiO_{X} particles was defined as the carbon coverage.

SiO_{X} having the lithium silicate phase formed therein and PAN (polyacrylonitrile), which is a binder, were mixed together at a mass ratio of 95:5 and were further mixed with NMP (N-methyl-2-pyrrolidone) as a diluent solvent. This was stirred using a mixer (ROBOMIX, manufactured by PRIMIX Corporation), whereby negative electrode mix slurry was prepared.

The negative electrode mix slurry was applied to one side of copper foil such that the mass of a negative electrode mix layer per square meter was 25 g/m². Next, this was dried at 105° C. in air and was then rolled, whereby a negative electrode was prepared. Incidentally, the packing density of the negative electrode mix layer was 1.50 g/ml.

### Preparation of Non-Aqueous Electrolyte Solution

To a solvent mixture prepared by mixing ethylene carbonate (EC) and diethyl carbonate (DEC) together at a volume ratio of 3:7, 1.0 mol/liter of lithium hexafluorophosphate (LiPF₆) was added, whereby a non-aqueous electrolyte solution was prepared.

### Assembly of Battery

An electrode assembly was prepared in an inert atmosphere using the negative electrode having a Ni tab attached to the outside edge thereof, lithium metal foil, and a polyethylene separator placed between the negative electrode and the lithium metal foil. The electrode assembly was placed into a battery enclosure made from an aluminium laminate, the non-aqueous electrolyte solution was poured in the battery enclosure, and the battery enclosure was sealed, whereby a battery was prepared. The battery, which was prepared as described above, is hereinafter referred to as Battery A1.

### Example 2

A battery was prepared in substantially the same manner as that described in Example 1 of the first example except that Li₂CO₃ was used as a lithium source instead of LiOH when the lithium source and SiO_{X} were mixed together and were heat-treated (the proportion of Li₂CO₃ to SiO_{X} was 10 mole percent). Incidentally, heat-treated SiO_{X} was analyzed by XRD, whereby peaks corresponding to Li₄SiO₄ and Li₂SiO₃, which are lithium silicates, were observed. The percentage of a lithium silicate phase in heat-treated SiO_{X} was 5 mole percent. The battery, which was prepared as described above, is hereinafter referred to as Battery A2.

### Example 4

A battery was prepared in substantially the same manner as that described in Example 1 of the first example except that LiCl was used as a lithium source instead of LiOH when the lithium source and SiO_{X} were mixed together and were heat-treated (the proportion of LiCl to SiO_{X} was 20 mole percent). Incidentally, heat-treated SiO_{X} was analyzed by XRD, whereby peaks corresponding to Li₄SiO₄ and Li₂SiO₃, which are lithium silicates, were observed. The percentage of a lithium silicate phase in heat-treated SiO_{X} was 5 mole percent. The battery, which was prepared as described above, is hereinafter referred to as Battery A3.

### Example 4

A battery was prepared in substantially the same manner as that described in Example 1 of the first example except that LiF was used as a lithium source instead of LiOH when the lithium source and SiO_{X} were mixed together and were heat-treated (the proportion of LiF to SiO_{X} was 20 mole percent). Incidentally, heat-treated SiO_{X} was analyzed by XRD, whereby peaks corresponding to Li₄SiO₄ and Li₂SiO₃, which are lithium silicates, were observed. The percentage of a lithium silicate phase in heat-treated SiO_{X} was 5 mole percent. The battery, which was prepared as described above, is hereinafter referred to as Battery A4.

### Comparative Example

A battery was prepared in substantially the same manner as that described in Example 1 of the first example except that SiO_{X} was not mixed with LiOH or was not heat-treated (that is, untreated SiO_{X} was used as SiO_{X} as a negative electrode active material). This SiO_{X} was analyzed by XRD; however, no lithium silicate phase was observed as shown in FIG. 1. The battery, which was prepared as described above, is hereinafter referred to as Battery Z.

### (Experiment)

Batteries A1 to A4 and Z were charged and discharged under conditions below and were investigated for the initial charge-discharge efficiency given by Equation (3) below and the tenth-cycle capacity retention given by Equation (4) below. The results are shown in Table 1.

### Charge and Discharge Conditions

After constant-current charge was performed at a current of 0.2 It (4 mA) until the voltage reached 0 V, constant-current charge was performed at a current of 0.05 It (1 mA) until the voltage reached 0 V. Next, after a rest was taken for 10 minutes, constant-current discharge was performed at a current of 0.2 It (4 mA) until the voltage reached 1.0 V.

### [Equation for Calculating Initial Charge-Discharge Efficiency]

Initial charge-discharge efficiency (%)=(first-cycle discharge capacity/first-cycle charge capacity)×100 (3)

### [Equation for Calculating Tenth-Cycle Capacity Retention]

Tenth-cycle capacity retention (%)=(tenth-cycle discharge capacity/first-cycle discharge capacity)×100 (4)

TABLE 1

| | | Amount of | Percentage of | Initial charge- | Tenth-cycle |
|---|---|---|---|---|---|
| | Lithium | added lithium | lithium silicate | discharge | capacity |
| Battery | compound | compound | phase in SiOₓ | efficiency | retention |
| A1 | LiOH | 20 mole percent | 5 mole percent | 72% | 45% |
| A2 | Li₂CO₃ | 10 mole percent | | 73% | 43% |
| A3 | LiCl | 20 mole percent | | 70% | 41% |
| A4 | LiF | 20 mole percent | | 71% | 41% |
| Z | — | — | 0 mole percent | 67% | 7% |

It is clear that Batteries A1 to A4, which use SiO_{X} having the lithium silicate phase therein, have enhanced initial charge-discharge efficiency and cycle properties as compared to Battery Z, which use SiO_{X} having no lithium silicate phase. This is because when SiO_{X} has the lithium silicate phase in advance before charge and discharge, the amount of lithium consumed by Li₄SiO₄, which is produced during initial charge, is small and the amount of lithium capable of being involved in charging and discharging is increased. SiO_{X} having the lithium silicate phase therein has the same charge capacity as that of SiO_{X} having no lithium silicate phase and a lower degree of expansion during charge as compared to SiO_{X} having no lithium silicate phase. Thus, the difference between expansion and shrinkage during charge and discharge is small and therefore separation or the like in a negative electrode mix layer is probably suppressed.

Incidentally, a lithium compound used for heat treatment is not limited to LiOH. It has been capable of being confirmed that Li₂CO₃, LiCl, or LiF exhibits a similar effect. Furthermore, it is conceivable that lithium compounds other than these exhibit a similar effect.

### Second Example

### Example 1

A battery was prepared in substantially the same manner as that described in Example 1 of the first example except that 2 mole percent of LiOH was added to SiO_{X} when LiOH and SiO_{X} were mixed together and were heat-treated. Incidentally, heat-treated SiO_{X} was analyzed by XRD, whereby a peak corresponding to Li₂SiO₃, which is a lithium silicate, was observed. The percentage of a lithium silicate phase in heat-treated SiO_{X} was 0.5 mole percent. The battery, which was prepared as described above, is hereinafter referred to as Battery B1.

### Example 2

A battery was prepared in substantially the same manner as that described in Example 1 of the first example except that 50 mole percent of LiOH was added to SiO_{X} when LiOH and SiO_{X} were mixed together and were heat-treated. Incidentally, heat-treated SiO_{X} was analyzed by XRD, whereby peaks corresponding to Li₄SiO₄ and Li₂SiO₃, which are lithium silicates, were observed. The percentage of a lithium silicate phase in heat-treated SiO_{X} was 12.5 mole percent. The battery, which was prepared as described above, is hereinafter referred to as Battery B2.

### Example 3

A battery was prepared in substantially the same manner as that described in Example 1 of the first example except that 80 mole percent of LiOH was added to SiO_{X} when LiOH and SiO_{X} were mixed together and were heat-treated. Incidentally, heat-treated SiO_{X} was analyzed by XRD, whereby peaks corresponding to Li₄SiO₄ and Li₂SiO₃, which are lithium silicates, were observed. The percentage of a lithium silicate phase in heat-treated SiO_{X} was 20 mole percent. The battery, which was prepared as described above, is hereinafter referred to as Battery B3.

### Example 4

A battery was prepared in substantially the same manner as that described in Example 1 of the first example except that 100 mole percent of LiOH was added to SiO_{X} when LiOH and SiO_{X} were mixed together and were heat-treated. Incidentally, heat-treated SiO_{X} was analyzed by XRD, whereby peaks corresponding to Li₄SiO₄ and Li₂SiO₃, which are lithium silicates, were observed. The percentage of a lithium silicate phase in heat-treated SiO_{X} was 25 mole percent. The battery, which was prepared as described above, is hereinafter referred to as Battery B4.

### (Experiment)

Batteries B1 to B4 were charged and discharged under the same conditions as those of the experiment described in the first example and were investigated for the initial charge-discharge efficiency given by Equation (3) and the tenth-cycle capacity retention given by Equation (4). The results are shown in Table 2. Incidentally, the results of Batteries A1 and Z are also shown in Table 2.

TABLE 2

| | | Percentage of | Initial charge- | Tenth-cycle |
|---|---|---|---|---|
| | Amount of | lithium silicate | discharge | capacity |
| Battery | added LiOH | phase in SiOₓ | efficiency | retention |
| B1 | 2 mole percent | 0.5 mole percent | 69% | 37% |
| A1 | 20 mole percent | 5 mole percent | 72% | 45% |
| B2 | 50 mole percent | 12.5 mole percent | 79% | 47% |
| B3 | 80 mole percent | 20 mole percent | 81% | 49% |
| B4 | 100 mole percent | 25 mole percent | 82% | 49% |
| Z | — | 0 mole percent | 67% | 7% |

It has become clear that Batteries A1 and B1 to B4, which use SiO_{X} having the lithium silicate phase therein, have higher initial charge-discharge efficiency and better cycle properties as compared to Battery Z, which use SiO_{X} having no lithium silicate phase. For comparisons between Batteries A1 and B1 to B4, it has become clear that the higher the percentage of the lithium silicate phase in SiO_{X} is, the higher the initial charge-discharge efficiency is and the better the cycle properties are. Furthermore, it has been capable of being confirmed that Batteries B2 to B4, in which the percentage of the lithium silicate phase in SiO_{X} is 12.5 mole percent or more, exhibit an initial charge-discharge efficiency exceeding the theoretical charge-discharge efficiency (75%) in the case of using SiO_{X} as a negative electrode active material.

From the above, the percentage of the lithium silicate phase in SiO_{X} is preferably 0.5 mole percent to 25 mole percent. When the percentage of the lithium silicate phase in SiO_{X} is less than 0.5 mole percent, the effect of forming the lithium silicate phase is low. When the percentage is more than 25 mole percent, the charge-discharge capacity is low.

### Third Example

### Example 1

A battery was prepared in substantially the same manner as that described in Example 1 of the first example except that SiO_{X} (x=0.93, a carbon coating amount of 10% by mass) with an average primary particle size of 1.0 μm was used as SiO_{X} (heat-untreated SiO_{X}) as a raw material. Incidentally, heat-treated SiO_{X} was analyzed by XRD, whereby peaks corresponding to Li₄SiO₄ and Li₂SiO₃, which are lithium silicates, were observed. The percentage of a lithium silicate phase in heat-treated SiO_{X} was 5 mole percent. The battery, which was prepared as described above, is hereinafter referred to as Battery C1.

### Example 2

A battery was prepared in substantially the same manner as that described in Example 1 of the first example except that SiO_{X} (x=0.93, a carbon coating amount of 10% by mass) with an average primary particle size of 15.0 μm was used as SiO_{X} (heat-untreated SiO_{X}) as a raw material. Incidentally, heat-treated SiO_{X} was analyzed by XRD, whereby peaks corresponding to Li₄SiO₄ and Li₂SiO₃, which are lithium silicates, were observed. The percentage of a lithium silicate phase in heat-treated SiO_{X} was 5 mole percent. The battery, which was prepared as described above, is hereinafter referred to as Battery C2.

### (Experiment)

Batteries C1 and C2 were charged and discharged under the same conditions as those of the experiment described in the first example and were investigated for the initial charge-discharge efficiency given by Equation (3) and the tenth-cycle capacity retention given by Equation (4). The results are shown in Table 3. Incidentally, the results of Batteries A1 and Z are also shown in Table 3.

TABLE 3

| | Average primary | | Percentage of | Initial charge- | Tenth-cycle |
|---|---|---|---|---|---|
| | particle | Amount of | lithium silicate | discharge | capacity |
| Battery | size of SiOₓ | added LiOH | phase in SiOₓ | efficiency | retention |
| C1 | 1 μm | 0.2 mole percent | 5 mole percent | 69% | 44% |
| A1 | 5 μm | | | 72% | 45% |
| C2 | 15 μm | | | 71% | 47% |
| Z | 5 μm | — | 0 mole percent | 67% | 7% |

It has become clear that Batteries A1, C1, and C2, which use SiO_{X} having the lithium silicate phase therein, have higher initial charge-discharge efficiency and better cycle properties as compared to Battery Z, which use SiO_{X} having no lithium silicate phase. Thus, the average primary particle size of SiO_{X} is preferably 1 μm to 15 μm. Incidentally, when the average primary particle size of SiO_{X} is less than 1 μm, the surface area of each particle is large and therefore a side reaction of an electrolyte solution is likely to occur. However, when the average primary particle size of SiO_{X} is more than 15 μm, lithium does not diffuse into SiO_{X} during chemical conversion treatment and a large amount of the lithium silicate phase is formed on the surface of SiO_{X}; hence, a reduction in capacity or reductions in load properties may possibly be caused.

### Fourth Example

### Example 1

A battery was prepared in substantially the same manner as that described in Example 1 of the first example except that an unreacted lithium compound was removed from the surface of heat-treated SiO_{X} in such a manner that heat-treated SiO_{X} was washed with pure water until the pH of a filtrate reached 8.0, followed by filtration. The battery, which was prepared as described above, is hereinafter referred to as Battery D1.

### Example 2

A battery was prepared in substantially the same manner as that described in Example 1 of the first example except that treatment below was performed before heat treatment.

When SiO_{X} and LiOH were mixed together, a predetermined amount of SiO_{X} and a predetermined amount of a nonionic surfactant (SN WET 980™, a polyether surfactant produced by San Nopco, Ltd.) were added to a solution prepared by dissolving LiOH in water in advance and were dispersed. Incidentally, the amount of the added nonionic surfactant was 1% by mass of the amount of solid matter. Next, the dispersion was dried in a thermostatic chamber preset to a temperature of 110° C. and water, that is, a solvent was removed, followed by heat treatment. The battery, which was prepared as described above, is hereinafter referred to as Battery D2.

### Example 3

A battery was prepared in substantially the same manner as that described in Example 2 of the fourth example except that an unreacted lithium compound was removed from the surface of heat-treated SiO_{X} in such a manner that heat-treated SiO_{X} was washed with pure water until the pH of a filtrate reached 8.0, followed by filtration. The battery, which was prepared as described above, is hereinafter referred to as Battery D3.

### (Experiment)

Batteries D1 to D3 were charged and discharged under the same conditions as those of the experiment described in the first example and were investigated for the initial charge-discharge efficiency given by Equation (3) and the tenth-cycle capacity retention given by Equation (4). The results are shown in Table 4. Incidentally, the results of Batteries A1 are also shown in Table 4.

TABLE 4

| | | | Initial charge- | Tenth-cycle |
|---|---|---|---|---|
| | | | discharge | capacity |
| Battery | Surfactant | Water washing | efficiency | retention |
| A1 | Not added | Not performed | 72% | 45% |
| D1 | | Performed | 74% | 47% |
| D2 | Added | Not performed | 73% | 48% |
| D3 | | Performed | 76% | 50% |

It is clear that Battery D1, for which water washing was performed after heat treatment, has enhanced initial charge-discharge efficiency and cycle properties as compared to Battery A1, for which water washing was not performed. Performing water washing as performed for Battery D1 enables the lithium compound, which is an unreacted substance during heat treatment, to be removed, whereby the surface resistance of particles of a negative electrode active material is reduced. This is probably because conductive paths are sufficiently formed between the negative electrode active material particles.

Furthermore, it is clear that Battery D2, for which wet treatment was performed using the surfactant in advance when heat-untreated SiO_{X} and the lithium compound were mixed together, has enhanced initial charge-discharge efficiency and cycle properties as compared to Battery A1, for which heat-untreated SiO_{X} and the lithium compound were simply dry-mixed together. Performing wet kneading by adding the surfactant as performed for Battery D1 allows fine LiOH to be uniformly precipitated on the surface of SiO_{X}. This is probably because a liquid crystal panel is more uniformly formed during heat treatment.

Furthermore, it is clear that Battery D3, for which wet treatment was performed using the surfactant and water-washing treatment was performed after chemical conversion treatment, has enhanced initial charge-discharge efficiency and cycle properties as compared to Batteries D1 and D2, for which only one of the treatments was performed. Thus, combining the two treatments enables properties to be further improved.

Incidentally, from the above experiment results, it has become clear that LiOH is preferably uniformly placed on the surface of SiO_{X}. Such a state can be achieved by dry treatment without being limited to the wet treatment.

### Fifth Example

### Example 1

### Preparation of Positive Electrode

Lithium cobaltate as a positive electrode active material, acetylene black (HS100 produced by Denki Kagaku Kogyo Kabushiki Kaisha) as a conductive agent, and polyvinylidene fluoride (PVdF) as a binder were weighed at a mass ratio of 95.0:2.5:2.5 and were mixed together, followed by adding N-methyl-2-pyrrolidone (NMP) as a dispersion medium thereto. Next, this was stirred using a mixer (T. K. HIVIS MIX manufactured by PRIMIX Corporation), whereby positive electrode slurry was prepared. Next, the positive electrode slurry was applied to both surfaces of a positive electrode current collector including aluminium foil and was dried, followed by rolling using a rolling roller, whereby a positive electrode including the positive electrode current collector and positive electrode mix layers formed on both surfaces thereof was prepared. Incidentally, the packing density of the positive electrode mix layers was 3.60 g/ml.

### Preparation of Negative Electrode

A negative electrode active material used was a mixture of graphite and heat-treated SiO_{X} used in Example 1 of the first example. Incidentally, the proportion of heat-treated SiO_{X} to the amount of the negative electrode active material was 5% by mass. The negative electrode active material, carboxymethylcellulose (CMC, #1380 produced by Daicel FineChem, Ltd., a degree of etherification of 1.0 to 1.5) as a thickening agent, and SBR (styrene-butadiene rubber) as a binder were mixed together at a mass ratio of 97.5:1.0:1.5, followed by adding water as a diluent solvent thereto. This was stirred using the mixer (T. K. HIVIS MIX manufactured by PRIMIX Corporation), whereby negative electrode slurry was prepared. Next, the negative electrode slurry was uniformly applied to both surfaces of a negative electrode current collector including copper foil such that the mass of each negative electrode mix layer per square meter was 190 g. Next, this was dried at 105° C. in air, followed by rolling using a rolling roller, whereby a negative electrode including the positive electrode current collector and positive electrode mix layers formed on both surfaces thereof was prepared. Incidentally, the packing density of the positive electrode mix layers was 1.60 g/ml.

### Preparation of Battery

The positive electrode and the negative electrode were arranged to face each other with a separator including a polyethylene porous membrane. Next, after a positive electrode tab and a negative electrode tab were attached to the positive electrode and the negative electrode, respectively, so as to be located at the outermost end of each electrode, the positive electrode, the negative electrode, and the separator were spirally wound, whereby an electrode assembly was prepared. Next, the electrode assembly was placed into a battery enclosure made from an aluminium laminate and was vacuum-dried at 105° C. for 2 hours. Thereafter, the same non-aqueous electrolyte solution as the non-aqueous electrolyte solution described in Example 1 of the first example was poured in the battery enclosure and the battery enclosure was sealed, whereby a non-aqueous electrolyte secondary battery was prepared. The design capacity of the non-aqueous electrolyte secondary battery is 800 mAh. The battery, which was prepared as described above, is hereinafter referred to as Battery E1.

### Example 2

A battery was prepared in substantially the same manner as that described in Example 1 of the fifth example except that the proportion of heat-treated SiO_{X} to the amount of the negative electrode active material was 10% by mass in the preparation of the negative electrode. The battery, which was prepared as described above, is hereinafter referred to as Battery E2.

### Example 3

A battery was prepared in substantially the same manner as that described in Example 1 of the fifth example except that the proportion of heat-treated SiO_{X} to the amount of the negative electrode active material was 20% by mass in the preparation of the negative electrode. The battery, which was prepared as described above, is hereinafter referred to as Battery E3.

### Comparative Examples 1 to 3

Batteries were prepared in substantially the same manner as that described in Examples 1 to 3 of the fifth example except that untreated SiO_{X} (heat-untreated SiO_{X}) was used as SiO_{X}. The batteries, which were prepared as described above, are hereinafter referred to as Batteries Y1 to Y3.

### (Experiment)

Batteries E1 to E3 and Y1 to Y3 were charged and discharged under conditions below and were investigated for the initial charge-discharge efficiency given by Equation (3) below and cycle life. The results are shown in Table 5. Incidentally, the number of cycles when reaching 80% of the first-cycle discharge capacity was defined as the cycle life. The cycle life of each battery is expressed in the form of an index determined on the basis that the cycle life of Battery Y1 is 100.

Furthermore, the rate of increase in initial charge-discharge efficiency and the rate of increase in cycle life are those obtained by comparing batteries having the same SiO_{X} mixing ratio. In the case of, for example, Battery E1, the rate of increase with respect to Battery Y1 is used.

### Charge and Discharge Conditions

After constant-current charge was performed at a current of 1.0 It (800 mA) until the voltage of each battery reached 4.2 V, constant-voltage charge was performed at a voltage of 4.2 V until the current reached 0.05 It (40 mA). Next, after a rest was taken for 10 minutes, constant-current discharge was performed at a current of 1.0 It (800 mA) until the battery voltage reached 2.75 V.

### Ratio x/Mc of Amount x of Lithium in Positive Electrode and Negative Electrode to Amount M_{c} of Metal Element M Contained in Positive Electrode Active Material

In each of these batteries, the amount x of lithium contained in the positive electrode and the negative electrode and the amount M_{c} of a metal element M contained in the positive electrode active material were determined as described above and the ratio x/Mc was calculated. The results are shown in Table 5.

TABLE 5

| | | | Initial | | | |
|---|---|---|---|---|---|---|
| | | | charge-discharge | | Cycle | |
| | | | efficiency | | properties | |
| | | Proportion of | | Rate of | | Rate of |
| | x/M_{c} | SiOₓ | Efficiency | increase | Cycle | increase |
| Battery | ratio | (mass percent) | (%) | (%) | life | (%) |
| E1 | 1.03 | 5 | 89 | 2.3 | 135 | 35 |
| Y1 | 1.01 | | 87 | | 100 | |
| E2 | 1.05 | 10 | 87 | 3.6 | 101 | 148 |
| Y2 | 1.01 | | 84 | | 42 | |
| E3 | 1.08 | 20 | 85 | 6.3 | 85 | 166 |
| Y3 | 1.01 | | 80 | | 32 | |

As is clear from Table 5, it is recognized that Batteries E1 to E3 have enhanced initial charge-discharge efficiency and cycle properties as compared to Batteries Y1 to Y3. Thus, it is clear that even in the case of using a negative electrode active material prepared by mixing SiO_{X} and graphite together, heat-treated SiO_{X} (SiO_{X} having a lithium silicate phase therein) is preferably used as SiO_{X}.

Furthermore, it is recognized that the higher the proportion of SiO_{X} is, the higher the rate of increase in initial charge-discharge efficiency and the rate of increase in cycle properties are. However, when the proportion of SiO_{X} is extremely high, the separation of a negative electrode mix layer may possibly be significant. Thus, the proportion of SiO_{X} is preferably 20% by mass or less. Incidentally, when the proportion of SiO_{X} is extremely low, the effect of adding SiO_{X} is not sufficiently exhibited. Therefore, the proportion of SiO_{X} is preferably 1% by mass or more.

### Sixth Example

### Example 1

### Preparation of Negative Electrode

A negative electrode active material used was a mixture of graphite and heat-treated SiO_{X} used in Example 1 of the first example. Incidentally, the proportion of heat-treated SiO_{X} to the amount of the negative electrode active material was 5% by mass. The negative electrode active material, carboxymethylcellulose (CMC, #1380 produced by Daicel FineChem, Ltd., a degree of etherification of 1.0 to 1.5) as a thickening agent, and SBR (styrene-butadiene rubber) as a binder were mixed together at a mass ratio of 97.5:1.0:1.5, followed by adding water as a diluent solvent thereto. This was stirred using a mixer (T. K. HIVIS MIX manufactured by PRIMIX Corporation), whereby negative electrode slurry was prepared. Next, the negative electrode slurry was uniformly applied to both surfaces of a negative electrode current collector including copper foil such that the mass of each negative electrode mix layer per square meter was 190 g. Next, this was dried at 105° C. in air, followed by rolling using a rolling roller, whereby a negative electrode was formed so as to include the negative electrode current collector and the negative electrode mix layers formed on both surfaces thereof. Incidentally, the packing density of the positive electrode mix layers was 1.60 g/ml.

### Preparation of Non-Aqueous Electrolyte Solution

To a solvent mixture prepared by mixing ethylene carbonate (EC) and diethyl carbonate (DEC) together at a volume ratio of 3:7, 1.0 mol/liter of lithium hexafluorophosphate (LiPF₆) was added, whereby a non-aqueous electrolyte solution was prepared.

### Assembly of Battery

An electrode assembly was prepared in an inert atmosphere using the negative electrode having a Ni tab attached to the outside edge thereof, lithium metal foil, and a polyethylene separator placed between the negative electrode and the lithium metal foil. The electrode assembly was placed into a battery enclosure made from an aluminium laminate, the non-aqueous electrolyte solution was poured in the battery enclosure, and the battery enclosure was sealed, whereby a battery was prepared. The battery, which was prepared as described above, is hereinafter referred to as Battery F1.

### Example 2

A battery was prepared in substantially the same manner as that described in Example 1 of the sixth example except that SiO_{X} (x=0.93, a carbon coating amount of 10% by mass) with an average primary particle size of 1.0 μm was used as SiO_{X} (heat-untreated SiO_{X}) as a raw material. Incidentally, heat-treated SiO_{X} was analyzed by XRD, whereby peaks corresponding to Li₄SiO₄ and Li₂SiO₃, which are lithium silicates, were observed. The battery, which was prepared as described above, is hereinafter referred to as Battery F2.

### Example 3

A battery was prepared in substantially the same manner as that described in Example 1 of the sixth example except that SiO_{X} (x=0.93, a carbon coating amount of 10% by mass) with an average primary particle size of 0.5 μm was used as SiO_{X} (heat-untreated SiO_{X}) as a raw material. Incidentally, heat-treated SiO_{X} was analyzed by XRD, whereby peaks corresponding to Li₄SiO₄ and Li₂SiO₃, which are lithium silicates, were observed. The battery, which was prepared as described above, is hereinafter referred to as Battery F3.

### Comparative Example 1

SiO_{X} (x=0.93, an average primary particle size of 15.0 μm) and 0.2 mol of LiOH (0.2 mole percent of LiOH with respect to SiO_{X}) were mixed together using a planetary ball mixer, whereby SiO_{X} with an average primary particle size of 5.0 μm was prepared. Furthermore, graphite was added thereto, was mixed, was hybridized with hard carbon, and was heat-treated at 800° C. for 5 hours in an Ar atmosphere, whereby a negative electrode active material with an average primary particle size of 40 μm was prepared.

A battery was prepared in substantially the same manner as that described in Example 1 of the sixth example except that the mass ratio of the negative electrode active material to graphite was 10:90 (SiO:graphite=5:95). The battery, which was prepared as described above, is hereinafter referred to as Battery Z1.

### Comparative Example 2

A battery was prepared in substantially the same manner as that described in Comparative Example 1 of the sixth example except that SiO_{X} (x=0.93, a carbon coating amount of 10% by mass), treated in a ball mill, having an average primary particle size of 1.0 μm was used and the average primary particle size of the negative electrode active material hybridized with hard carbon was 8.0 μm. The battery, which was prepared as described above, is hereinafter referred to as Battery Z2.

### Comparative Example 3

A battery was prepared in substantially the same manner as that described in Comparative Example 1 of the sixth example except that SiO_{X} (x=0.93, a carbon coating amount of 10% by mass), treated in a ball mill, having an average primary particle size of 0.5 μm was used and the average primary particle size of the negative electrode active material hybridized with hard carbon was 4.0 μm. The battery, which was prepared as described above, is hereinafter referred to as Battery Z3.

Incidentally, the negative electrode active material used in Batteries Z1 to Z3 prepared in Comparative Examples 1 to 3 of the sixth example is close in content to Patent Literature 2.

### (Experiment)

### (Battery Performance Evaluation)

Batteries F1 to F3 and Z1 to Z3 were measured for initial charge capacity and the initial charge-discharge efficiency given by Equation (3). The results are shown in Table 6. Incidentally, charge and discharge conditions are the same as the conditions of the experiment described in the first experiment.

TABLE 6

| | Average primary | Particle | Initial | Initial charge- |
|---|---|---|---|---|
| | particle | size of active | charge | discharge |
| Battery | size of SiOₓ | material | capacity | efficiency |
| F1 | 5 μm | 5 μm | 437 mAh/g | 91% |
| F2 | 1 μm | 1 μm | 426 mAh/g | 90% |
| F3 | 0.5 μm | 0.5 μm | 420 mAh/g | 88% |
| Z1 | 5 μm | 40 μm | 387 mAh/g | 83% |
| Z2 | 1 μm | 8 μm | 412 mAh/g | 86% |
| Z3 | 0.5 μm | 5 μm | 420 mAh/g | 87% |

As is clear from Table 6, it is recognized that Batteries F1 to F3 have enhanced initial charge capacity and initial charge-discharge efficiency as compared to Batteries Z1 to Z3. The negative electrode active material used in Batteries Z1 to Z3 has a structure in which SiO is dispersed in carbonaceous matter. On the other hand, the negative electrode active material used in Batteries F1 to F3 has a structure in which a thin carbon coating is present on the surface of SiO. It is recognized that when the particle size of SiO less than 1.0 μm, differences between battery properties due to the difference between the structure in which SiO is dispersed in carbonaceous matter and the structure in which the thin carbon coating is present on the surface of SiO are small. On the other hand, it is clear that when the particle size of SiO is 1.0 μm or more, the structure in which the thin carbon coating is present on the surface of SiO has higher initial charge capacity and initial charge-discharge efficiency. This is probably because in the structure in which SiO is dispersed in carbonaceous matter as described in Patent Literature 2, carbonaceous matter covering SiO acts as resistance to reduce the utilization efficiency of SiO during charge and discharge. From the results in Table 6, the effect of increasing the utilization efficiency of SiO to raise initial efficiency is recognized in the case of the structure in which the thin carbon coating is present on the surface of SiO and in the case where the particle size is 1.0 μm or more.

### Seventh Example

### Example 1

A battery was prepared in substantially the same manner as that described in Example 2 of the first example except that the proportion of carbon to SiO_{X} was 2% by mass and the carbon coverage of the surface of SiO_{X} was 80%. The battery, which was prepared as described above, is hereinafter referred to as Battery G1.

### Example 2

A battery was prepared in substantially the same manner as that described in Example 2 of the first example except that the proportion of carbon to SiO_{X} was 1.5% by mass and the carbon coverage of the surface of SiO_{X} was 50%. The battery, which was prepared as described above, is hereinafter referred to as Battery G2.

### Comparative Example 1

A battery was prepared in substantially the same manner as that described in Example 2 of the first example except that the surface of SiO_{X} was not covered by carbon. The battery, which was prepared as described above, is hereinafter referred to as Battery R1.

### Comparative Example 2

A battery was prepared in substantially the same manner as that described in Comparative Example 1 of the first example except that the surface of SiO_{X} was not covered by carbon. The battery, which was prepared as described above, is hereinafter referred to as Battery R2.

### (Experiment)

Batteries G1, G2, R1 and R2 were charged and discharged under the same conditions as those of the experiment described in the first example and were investigated for the initial charge-discharge efficiency given by Equation (3) and the tenth-cycle capacity retention given by Equation (4). The results are shown in Table 7. Incidentally, the results of Batteries A2 and Z are also shown in Table 7.

TABLE 7

| | Carbon coating | Carbon | Percentage of | Initial charge- | Tenth-cycle |
|---|---|---|---|---|---|
| | amount of | coverage of | lithium silicate | discharge | capacity |
| Battery | surface of SiOₓ | surface of SiOₓ | phase in SiOₓ | efficiency | retention |
| A2 | 10 mass percent | 100% | 5 mole percent | 73% | 43% |
| G1 | 2 mass percent | 80% | | 70% | 39% |
| G2 | 1.5 mass percent | 50% | | 69% | 38% |
| R1 | — | — | | 60% | 20% |
| R2 | — | — | 0 mole percent | 55% | 5% |
| Z | 10 mass percent | 100% | 0 mole percent | 67% | 7% |

As is clear from Table 7, it is recognized that Batteries A2, G1, and G2, in which 50% or more of the surface is covered by carbon and SiO_{X} having a lithium silicate phase is used, have enhanced initial charge-discharge efficiency and cycle properties as compared to Batteries R1, R2, and Z.

### INDUSTRIAL APPLICABILITY

The present invention is applicable to, for example, power supplies for driving mobile information terminals such as mobile phones, notebook personal computers, and PDAs, particularly to applications requiring high capacity. Furthermore, development can be expected in high-power applications requiring continuous operation and applications, such as electric vehicles and electric tools, where the operating environment of batteries is severe.

1. A negative electrode active material for non-aqueous electrolyte secondary batteries, comprising particles made of SiO_{X} (0.8≦X≦1.2) containing a lithium silicate phase, wherein 50% to 100% of the surface of each particle made of SiO_{X} is covered by carbon.

2. The negative electrode active material according to claim 1, wherein the percentage of the lithium silicate phase in SiO_{X} is 0.5 mole percent to 25 percent.

3. The negative electrode active material according to claim 1, wherein 100% of the surface of each particle made of SiO_{X} is covered by carbon.

4. The negative electrode active material according to claim 1, wherein the average primary particle size of the particles made of SiO_{X} is 1 μm to 15 μm.

5. The negative electrode active material according to claim 1, further comprising graphite.

6. A non-aqueous electrolyte secondary battery comprising:
a negative electrode containing the negative electrode active material according to claim 1;
a positive electrode containing a positive electrode active material;
a separator placed between the positive electrode and the negative electrode; and
a non-aqueous electrolyte.

7. The non-aqueous electrolyte secondary battery according to claim 6, wherein the positive electrode active material contains lithium and an oxide containing a metal element M, the metal element M includes at least one selected from the group consisting of cobalt and nickel, and the ratio x/M_{c} of the sum x of the amount of lithium contained in the positive electrode and the amount of lithium contained in the negative electrode to the amount M_{c} of the metal element M contained in the oxide is more than 1.01.

8. The negative electrode active material according to claim 1, wherein the particle is covered by a carbon coating with a thickness of 1 nm to 200 nm.

9. The negative electrode active material according to claim 1, wherein the percentage of carbon in the particle is 10% by mass or less.
